(19) United States
(12) Patent Application Publication
(10) Pub. No.: US 2026/0220045 A1
(43) Pub. Date: Jul. 30, 2026

(54) DYNAMIC PARTITIONING FOR NETWORK CONTROL FOR NETWORKED SYSTEM

(71) Applicant: Capital One Services, LLC, McLean, VA (US)

(72) Inventors: Nikhil AGARWAL, Clarksburg, MD (US); Rajeesh KOYTHATTA MEE, Schaumburg, IL (US)

(73) Assignee: Capital One Services, LLC, McLean, VA (US)

(21) Appl. No.: 19/041,951

(22) Filed: Jan. 30, 2025

(51) Int. Cl. G06F 12/0806

(52) U.S. Cl. CPC G06F 12/0806

(57) ABSTRACT

A system may increase measurement retrieval by using multiple partitions for data. Some embodiments may determine how many partitions to allocate to a user. Furthermore, some embodiments may send warm-up requests to the partitions before using them in a production environment.

### SUMMARY

Distributed applications provide a framework for organizations to access scalable, flexible computational resources across multiple interconnected systems. These applications enable the division of computational tasks and data processing across numerous networked computers, allowing for more efficient resource utilization and potential performance improvements. By enabling workload distribution, shared computational resources, and parallel processing capabilities, distributed applications create opportunities for handling complex computational challenges that would be difficult or impossible for single-system architectures. However, the architectural approach of spreading computational tasks across different machines inherently introduces latency and communication overhead, which can significantly impede the performance and responsiveness of the overall system.

Some embodiments may resolve such issues and other issues by allocating and then using multiple in-memory shards to store data for a user. Some embodiments may allocate cache partitions stored in multiple server-side nodes by selecting a number of partitions based on a request execution rate associated with the user. Some embodiments may then store multiple request record subsets from a set of records for the user in multiple cache partitions of the multiple nodes. By determining whether to assign multiple partitions based on a user-related value or how many partitions to assign based on a user-related value, some embodiments may optimize memory organization for faster data retrieval. Some embodiments may then receive a request including instructions to retrieve data related to the user or cause the retrieval of such data. When retrieving data, some embodiments may send queries to each of the separate partitions to execute in parallel, concurrently, or in series. Such parallel or concurrent execution allows the system to retrieve data more quickly and efficiently.

By performing operations and using related devices described in this disclosure, some embodiments may provide a faster distributed data system that may execute database queries more quickly or permit or restrict database transactions more rapidly. Such operations may provide low latency communication that leads to reduced overall processing time for complex analytics, machine learning model training, real-time reporting, and data transformation workflows. Moreover, a system using multiple database partitions possesses increased system resiliency by ensuring that if one partition fails, other partitions can continue to operate and serve data, thereby maintaining overall service availability.

Various other aspects, features, and advantages of the invention will be apparent through the detailed description of the invention and the drawings attached hereto. It is also to be understood that both the foregoing general description and the following detailed description are examples and are not restrictive of the scope of the invention.

### BRIEF DESCRIPTION OF THE DRAWINGS

FIG. 1 shows an example system for fast measurement retrieval by using multiple cache partitions, in accordance with one or more embodiments.

FIG. 2 shows an example conceptual architecture showing fast measurement retrieval by using multiple cache partitions, in accordance with one or more embodiments.

FIG. 3 shows a flowchart of a process for fast measurement retrieval by using multiple cache partitions, in accordance with one or more embodiments.

FIG. 4 shows a flowchart of a process for initializing multiple partitions, in accordance with one or more embodiments.

The technologies described herein will become more apparent to those skilled in the art by studying the detailed description in conjunction with the drawings. Embodiments of implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

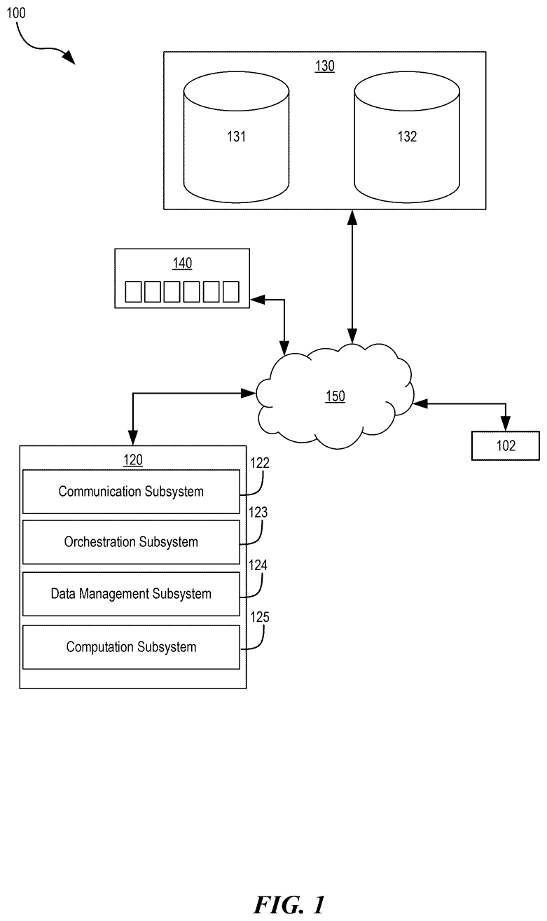

FIG. 1 shows an example system 100 for fast measurement retrieval by using multiple cache partitions, in accordance with one or more embodiments. A system 100 includes a client device 102 in communication with a server 120 via a network 150. As will be described further in this disclosure, the server 120 may perform operations to quickly retrieve data from an in-memory system (e.g., retrieval in less than 1 second, less than 10 milliseconds, 1 millisecond, less than 800 microseconds, less than 600 microseconds, etc.).

In some embodiments, the system 100 may allocate cache partitions to the user based on a user-specific value stored in association with the user, where the cache partitions are distributed between multiple networked nodes and includes at least a first partition and a second partition. By selectively partitioning cache memory based on user-related values, some embodiments may conserve memory partitions for user data that are most likely to require the partitions and further conserve processing power during data retrieval operations. Some embodiments may then store multiple record subsets in the multiple cache partitions and then quickly retrieve user-related data from the multiple cache partitions. Some embodiments may then perform calculations or other operations to determine an aggregated feature value by executing a first retrieval request for the first partition and a second retrieval request for the second partition, based on an aggregated data request. Based on this aggregated feature value, some embodiments may then execute one or more additional database transactions.

In some embodiments, the system 100 may allocate multiple cache partitions to the user based on a user-specific value, distributing these partitions across multiple networked nodes. In some embodiments, the system 100 may store multiple record subsets or other data in the multiple cache partitions. The system 100 may then receive a data retrieval request and execute (e.g., in parallel, concurrently, or in series) retrieval requests for each of the respective partitions of the multiple cache partitions based on an aggregated data request. By retrieving the data from multiple caches in parallel or concurrently, some embodiments may dramatically accelerate data retrieval operations. Some embodiments may determine an aggregated feature value based on the retrieved data and execute an additional database transaction or other operation based on the aggregated feature value.

The system 100 may allocate cache partitions to a user based on a user-specific value, store different data subsets to different cache partitions, and determine an aggregated measurement by executing retrieval requests for both partitions based on a request for the aggregated measurement. For example, some embodiments may concurrently execute a first retrieval request for a first partition and a second retrieval request for a second partition, where the retrieval requests may include one or more search values that defines the parameters or filters for a search (e.g., a user identifier, a timestamp range, etc.). Some embodiments may then retrieve one or more values from each of the searched partitions and send the payloads resulting from the different retrieval request to a computing node that computes one or more aggregated measurements (e.g., determine a maximum value, a minimum value, another type of extrema, a mean average, a median value, a mode, etc.). Some embodiments may then provide the aggregated measurement to a machine learning model as an input to determine an output. Based on the output, some embodiments may perform one or more additional operations, such as sending a message to an endpoint to effectuate a database transaction or perform another type of operation (e.g., locking one or more records, removing a user authorization, modifying one or more distributed application orchestration parameters, etc.). Such operations may reduce data retrieval time, thereby providing low latency communication used to fuel data retrieval operations for machine learning applications, data-checking services, or other operations described in this disclosure. Low latency communication may include response times less than 100 milliseconds or response times less than 50 millisecond. Furthermore, some operations for retrieving data from distributed caches described in this disclosure may provide ultra-low latency communication, such as less than 10 milliseconds or even less than 1 millisecond.

The client device 102 may include a laptop, data terminal, mobile computing device, etc. The client device 102 may send requests, responses, or other messages to the server 120 that may require communication with other computing devices or other electronic devices. Additionally, the server 120 may include various types of computing units, such as physically separate servers, virtual nodes hosted on one or more physical machines, or nodes on a cloud computing system. Applications, services, or other operations may use data provided by the client device 102, the server 120, a distributed cache system 140, or a set of databases 130 that includes a first networked database 131 and a second networked database 132. The set of databases 130 may include various types of databases, such as SQL databases, no SQL databases, graph databases, etc. In some embodiments, the server 120 may perform one or more operations related to a communication subsystem 122, an orchestration subsystem 123, a data management subsystem 124, or a computation subsystem 125.

In some embodiments, the communication subsystem 122 may obtain program instructions, commands, parameters, values, or other data from the client device 102, the set of databases 130, or the distributed cache system 140. For example, the communication subsystem 122 may retrieve a set of parameters from the set of databases 130. Furthermore, operations performed by the server 120 may use the communication subsystem 122 to send messages to the set of databases 130, the client device 102, the distributed cache system 140, or another computing device described in this disclosure. The distributed cache system 140 may be or may include internet distributed caches, where a user may control the configuration or operations of the distributed cache system 140 via the Internet or may store data into the distributed cache system 140 via the Internet. Furthermore, some embodiments may use the communication subsystem 122 to communicate with one or more remote computing devices to offload some or all of the operations described in this disclosure. For example, some embodiments may use the communication subsystem 122 to provide a remote computing system with data retrieved from the distributed cache system 140 to determine a sum, product, or other aggregated value. The communication subsystem 122 may then provide the aggregated value to a machine learning model to obtain a model result.

In some embodiments, the orchestration subsystem 123 may determine various resource allocations, including initializing and allocating resources related to the distributed cache system 140. In some embodiments, the orchestration subsystem 123 may receive a request to allocate one or more cache partitions for a user or may receive a request that causes such allocation. For example, the orchestration subsystem 123 may receive a direct request from a client device to allocate one or more cache partitions for a user, such as receiving a request to allocate five cache partitions to handle increased data storage needs. Alternatively, the orchestration subsystem 123 may receive a request that indirectly causes the allocation of cache partitions. For example, the server 120 may receive, from a user, a request to register the user for an account or to effectuate an update to a data system for the first time. In response, the server 120 may determine that, based on a user-related value (e.g., a category associated with the user, etc.), the user should be assigned with multiple cache partitions to be stored in the distributed cache system 140. For example, if the request execution rate for a user is 10 executed requests per day and this rate is greater than a rate threshold of 5 executed requests per day, the system may allocate multiple cache partitions amongst multiple nodes to handle this rate efficiently.

In some embodiments, the data management subsystem 124 may store into and retrieve data from the distributed cache system 140. Some embodiments may store multiple record subsets from a set of user records in various cache partitions across multiple nodes. For example, over the course of receiving 500 database updates involving a user record, the data management subsystem 124 may distribute 100 records of the updates across five separate partitions in the distributed cache system 140. Some embodiments may also receive instructions to otherwise be caused to retrieve data from the distributed cache system 140. For example, some embodiments may receive a user-provided request to retrieve data related to the user stored in the distributed cache system 140 that was stored within the past two days. Alternatively, some embodiments may receive a request to predict a user's security vulnerability based on a set of historical access times. In response, some embodiments may retrieve data stored in multiple cache partitions in the distributed cache system 140, process this data to generate an aggregated feature value indicating a maximum and minimum time of day of access, and then use these features as input values for a machine learning model to make predictions.

When retrieving data, the data management subsystem 124 may retrieve data from the distributed cache system 140 in parallel. For example, when a user request is received, some embodiments may simultaneously send a query to each of five different cache partitions distributed across five server-side nodes, where each node executes its search at the same time as the others. It should be understood that a set of operations that are done in parallel with respect to a set of partitions or a set of nodes may include operations that occur in parallel for some but not all partitions or nodes. For example, some embodiments may execute a first query, second query, and third query that occurs in parallel by executing a first query for a first partition, then, as the first partition is being searched, begin executing a second query for a second partition, then, after the first query is completed and while the second partition is still being searched, executing a third query for a third partition.

After obtaining individual query results from each of the partitions of the distributed cache system 140, the data management subsystem 124 may send payloads including the results to a downstream computation system, such as the computation subsystem 125. Alternatively, the data management subsystem 124 may perform one or more preliminary operations to aggregate the results into an aggregated value before sending the aggregated value to a downstream system.

In some embodiments, the data management subsystem 124 may send warm-up responses to an initialized partition to warm-up the partition for data retrieval operations before the initialized partition is actually used to retrieve data for a user. For example, the data management subsystem 124 may first extract data from an old partition or set of partitions to load the data onto a new partition or set of partitions. The data management subsystem 124 may then generate or otherwise obtain a set of warm-up data retrieval requests for one or more users in the data. The warm-up requests may include a request for data for a set of actual user data, a request for a set of dummy user data, etc. Using warm-up requests may speed up data retrieval from a partition by taking advantage of data retrieval mechanisms built into a cache, increasing the likelihood that retrieval operations can access the data quickly and efficiently before a cache is used.

In some embodiments, the computation subsystem 125 may determine function outputs, machine learning model outputs, or perform other types of computations that are then used to determine whether to perform one or more downstream operations. For example, some embodiments may determine a first aggregated measurement representing a maximum value of a set of values stored in the distributed cache system 140 and a second aggregated measurement representing a minimum value of a set of values stored in the distributed cache system 140.

Some embodiments may determine a decision model result by providing one or more aggregated measurements or other data based on data stored in the distributed cache system 140 as an input to a decision model. For instance, after retrieving and aggregating data from multiple cache partitions, the system may use this aggregated measurement as input to a decision model. The decision model then processes this input to generate a result, such as predicting user behavior or identifying potential anomalies. Based on this decision model result, the system may take further actions, such as sending a message to an endpoint to execute an additional network request or perform a database transaction.

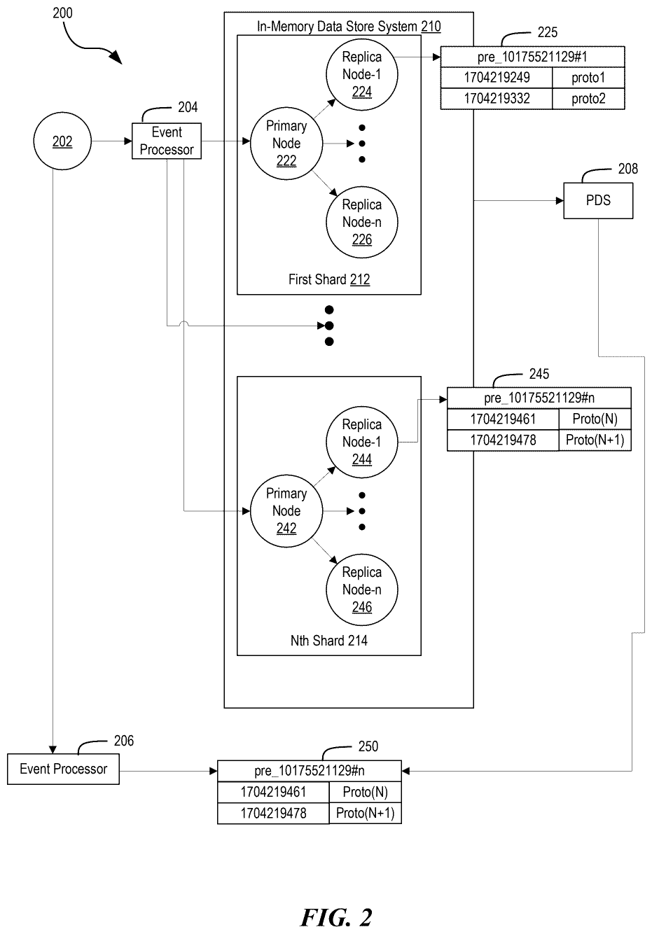

FIG. 2 shows an example conceptual architecture showing fast measurement retrieval by using multiple cache partitions, in accordance with one or more embodiments. An in-memory data store system 210 is used to store multiple physical shards, such as a first shard 212 and a second shard 214, where the in-memory data store system 210 may be used to store various other number of shards, such as four shards, five shards, six or more shards, ten or more shards, or various other numbers of shards. The first shard 212 may store multiple virtual nodes acting as virtual shards for multiple users. The first shard 212 may store a primary node 222 that then points to a first node 224 (labeled “Replica Node-1”) and a second node 226 (labeled “Replica Node-n”). The second shard 214 may store a primary node 242 that then points to a third node 244 (labeled “Replica Node-1”) and a fourth node 246 (labeled “Replica Node-n”). It should be understood that the in-memory data store system 210 may be used to store various numbers of physical shards, such as one shard, two shards, five shards, ten shards, twenty shards, or some other number of shards. Additionally, a physical shard may store any number of nodes.

A cluster orchestration system 202 may receive an initial database operation request or some other instruction that would be processed by an event processor 204 to cause the creation of the multiple physical shards or the allocation of an additional set of virtual shards. During initialization of an additional set of cache partitions, some or all of the shards of the in-memory data store system 210 may be used to store data, such as a record data. An in-memory data store system may act as a cache system that may be used to quickly retrieve data relative to other data storage systems, such as a solid-state drive or a spinning disk system.

As shown by the in-memory data store system 210, user account data (e.g., account PreAuth data) may be divided into multiple distinct sorted sets that are organized and distributed across multiple partitions that may be stored in one or more shards. This partitioning approach allows for faster data retrieval and improved performance by enabling parallel processing and reducing the load on individual storage units. It should be understood that a shard is a subset of data storage that may be stored in one node or distributed across multiple nodes to improve performance or resilience, and further that a partition may be a logical division of data. In some embodiments, an administrator may control the division of data into partitions, whereas an automated infrastructure management system may then distribute a single partition into multiple shards or restrict the partition into a single shard based on infrastructure configuration parameters.

For example, the first node 224 may be used to store a first set of user-related record data 225, where the first set of user-related record data 225 may store a first subset of data related to user 10175521129, and where individual records of the first set of user-related record data 225 may include timestamps being used as scores (e.g., “1704219249”) and serialized protobuffers (e.g., “proto1”). Similarly, the third node 244 may be used to store a second set of user-related record data 245, where the first set of user-related record data 225 may store a second subset of data related to user 10175521129, and where individual records of the second set of user-related record data 245 may include timestamps being used as scores (e.g., “1704219461”) and serialized protobuffers (e.g., “proto(N)”). It should be understood that a serialized protobuffer may include a compressed, language-agnostic binary representation that can be deserialized back into an original structure by a system that understands a predefined message schema. Some embodiments may use a serialized protobuffer due to its relatively smaller size and increased efficiency during deserialization in comparison to other data formats. Furthermore, as stated elsewhere in this disclosure, the data stored in the in-memory data store system 210 may be stored in the form of sorted sets. For example, each entry or record may be part of a sorted set that is indexed by keys following the template “pre_{{Account id))#{{shard_no))” to identify a logical partition for a user's data. Furthermore, each entry in the sorted set may include a timestamp, such as an auth timestamp, as a score used to identify a specific record entry.

Some embodiments may allocate data in other in-memory allotments of the in-memory data store system 210. Alternatively, some embodiments may store data in a cache memory that is not part of the in-memory data store system 210. For example, during a post-authorization operation, some embodiments may receive Account PostAuth Data. Some embodiments may store Account PostAuth Data or other data in an additional cache 250.

During a data retrieval operation for a user's data, a parallel distribution system (PDS) 208 may retrieve entries from each of the partitions assigned to the user in the in-memory data store system 210 in parallel. For example, the PDS 208 may retrieve 200 entries related to the user from the first shard 212, retrieve another 200 entries related to the user from the second shard 214, and retrieve an additional 200 entries related to the user from any other shards storing user data in the in-memory data store system 210.

In some embodiments, an event processor 206 may be responsible for handling incoming post Auth database transactions or other post Auth data and store user-related data for a user in the additional cache 250. In some embodiments, the PDS 208 may retrieve post Auth data stored in the additional cache 250. For example, each entry or record may be part of a sorted set that is indexed by keys following the template “POST{{Account id}}” to identify a single partition for the user's PostAuth data. Furthermore, each entry in the sorted set may include a timestamp, such as an auth timestamp, as a score used to identify a specific record entry.

### Flowchart

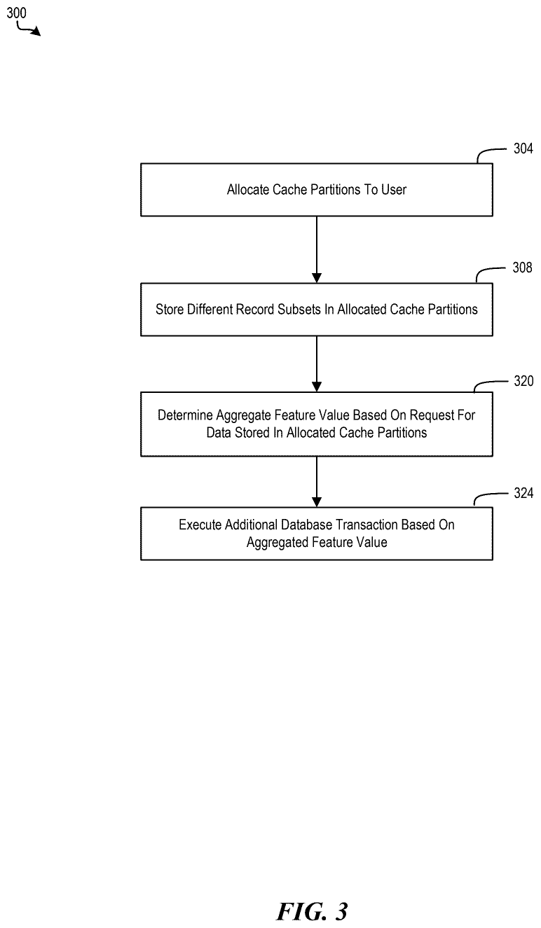

FIG. 3 shows a flowchart of a process 300 for fast measurement retrieval by using multiple cache partitions, in accordance with one or more embodiments. Some embodiments may allocate cache partitions to a user, as indicated by block 304. Some embodiments may allocate cache partitions to a user based on a user-specific value stored in association with the user. These cache partitions may be distributed between multiple networked nodes and include multiple partitions, such as a first partition and a second partition. For example, some embodiments may allocate five cache partitions to a user based on a unique identifier associated with the user. These cache partitions may be distributed across multiple shards, where each shard may themselves be restricted to one node or distributed across multiple networked nodes to ensure efficient data retrieval. Furthermore, at least in some embodiments, the allocation of multiple cache partitions may also cause the allocation of multiple shards. For example, some embodiments may cause sharding of a database when initializing a partitioning operation. Alternatively, some embodiments may work with pre-sharded databases and allocate partitions amongst the shards of the pre-sharded database. For example, some embodiments may receive a transaction for a new user and allocate three partitions to a pre-sharded database that includes three or more shards.

Some embodiments may first receive requests from a user via a client device connected to the Internet and allocating Internet-connected cache partitions stored across multiple server-side nodes. The allocation process may involve selecting a number of partitions for these cache partitions based on a request execution rate associated with the user. These Internet-connected cache partitions may then be distributed among the multiple server-side nodes, ensuring efficient handling of user requests and optimized performance across the network. For example, some embodiments may select a number of partitions for a set of cache partitions based on a request execution rate (e.g., selecting five user-specific partitions distributed amongst five physical partitions based on the execution rate satisfying a “high-frequency user” threshold). Some embodiments may distribute these Internet-connected cache partitions among the five server-side nodes storing the five physical partitions to increase efficient handling of user requests and optimized performance across the network.

In some embodiments, a node count of the multiple networked nodes may be equal to or greater than a partition count of the cache partitions. For example, some embodiments may have access to have networked nodes. Some embodiments may be configured to assign five cache partitions to a user and select one of the partitions to store a database transaction record in whenever a database transaction involving that user is attempted. Some embodiments may distribute the five cache partitions evenly between the five nodes, such that each node is allocated with one partition. Furthermore, some embodiments may be configured to assign a lesser number of partitions to a greater number of nodes, such as five user-specific partitions to ten nodes, such that five nodes have a user-specific partition, and five nodes do not. Furthermore, some embodiments may be configured to assign a greater number of partitions to a lesser number of nodes, such as six user-specific partitions to five nodes, such that four nodes have a single user-specific partition and one node stores two user-specific partitions.

Some embodiments may store different record subsets in allocated cache partitions, as indicated by block 308. Some embodiments may store a first record subset in the first partition of the cache partitions and a second record subset in the second partition of the cache partitions. For example, some embodiments may allocate multiple cache partitions across different server nodes to store user data efficiently. In this scenario, some embodiments may store records from a first subset of records (e.g., divided based on timestamp modulo values) in the first partition and records from a second subset of records in the second partition. When a user requests data for a specific time range, some embodiments may retrieve the relevant records from both partitions simultaneously, optimizing performance and ensuring faster data access.

Some embodiments may store a first request record subset in a first partition of the Internet-connected cache partitions and a second request record subset in a second partition of the Internet-connected cache partitions. An internet-connected cache partition may include This method allows for efficient organization and retrieval of data by distributing different subsets of request records across multiple cache partitions. By doing so, the system can optimize performance and ensure that data is readily accessible when needed, enhancing the overall efficiency of handling user requests.

When storing data in a cache, some embodiments may store timestamp data. For example, some embodiments may store a first record subset in a first partition, where the first record includes a timestamp “20250102162852” being used as a score for the record. Some embodiments may also use the timestamp or another value associated with a record (e.g., an existing index value or other value associated with a database transaction, a randomly generated value being used as a score) to select a partition for the record. For example, some embodiments may determine a modulo value based on a timestamp and the count of the cache partitions. For example, after receiving a record having the score “20250102162852,” some embodiments may determine “20250102162852” modulo “5,” which is equal to “2.” In response, some embodiments may then select a partition labeled “2” as the partition to store the record.

Some embodiments may determine an aggregate feature value based on a request for data stored in allocated cache partitions, as indicated by block 320. Some embodiments may determine an aggregated feature value by executing, based on an aggregated data request, a first retrieval request for the first partition and a second retrieval request for the second partition. Some embodiments may perform these retrieval quests in parallel or with at least some degree of concurrency. This approach allows the system to efficiently retrieve and process data from multiple partitions, ensuring that the aggregated feature value is accurate and comprehensive. By concurrently executing these retrieval requests, the system can optimize performance and provide timely responses to user queries. For example, some embodiments may perform retrieval operations in times less than 1 millisecond (e.g., 600 microseconds), whereas performing similar data retrieval operations using only a single cache partition may take more than 1 millisecond (e.g., 2.5 milliseconds).

Some embodiments may obtain a feature calculation request from a client device and then detect that a required partition storing data used to perform the feature calculation is inaccessible (e.g., due to a natural disaster, due to a power outage, or due another technical failure). In response, some embodiments may determine a partial result based on values stored in the second partition without using values stored in the first partition. For example, some embodiments may detect that the first partition used to store data for a user is inaccessible due to a failure for the first partition to send a recurring message or a response to a request. Some embodiments may then calculate the partial result using only the data available in a set of other cache partitions also storing data related to the user. For example, some embodiments may determine a maximum value of the available retrieved data as a partial result. By performing such operations, some embodiments may compensate for a lost partition. As described elsewhere, some embodiments may then effectuate a transaction based on this partial result.

Some embodiments may determine search values based on a payload request related to the user and then determine an aggregated measurement by concurrently executing, based on the search values, a first retrieval request for the first partition and a second retrieval request for the second partition. The system then sends a first payload resulting from the first retrieval request and a second payload resulting from the second retrieval request to a computing node. This approach allows for efficient data retrieval and aggregation, ensuring that the system can handle user requests effectively and provide accurate measurements based on the retrieved data.

Some embodiments may allocate an additional partition on a computation node to store one or more aggregated values associated with a first time range for the user. For example, some embodiments may store the average feature value for a feature “feature1,” maximum feature value for “feature1,” and minimum feature value for “feature1” of the most recent two months of interactions for a user. Some embodiments may then use this time range to determine whether to use the data in the additional partition or retrieve data from a partitioned cache instead. For example, some embodiments may receive a request for a maximum value for a specific period, such as from “2024 Jan. 1” to “2024 Jan. 31,” and use this time range as part of a set of search values. Some embodiments may then determine that this set of search values is within the first time range and, in response, directly use the previously calculated data instead of retrieving data from the set of partitions. Alternatively, some embodiments may then determine that this set of search values exceeds the first time range and, in response, retrieve data from multiple partitions stored in multiple shards. By performing such operations, some embodiments may store an additional cache of the most recently received transaction data on a compute node, where such operations may be useful should one or more repeat requests for the same data be made.

Some embodiments may store pre-calculated values in association with one or more users in a cache and retrieve the pre-calculated values. For example, after receiving a set of data and storing the set of data in a cache, some embodiments may then pre-calculate a maximum value, minimum value, median value, or mean average value based on the set of data values stored in cache. Some embodiments may then store the pre-calculated values in an already-used cache partition or in an additional cache partition for use. For example, some embodiments may obtain a first request that indicates a search value representing a time range and determine a first result indicating that the time range exceeds a first time range of data used to determine a pre-calculated value. Some embodiments may determine an additional result based on receiving a second request that indicates a second search value representing a time range within the first time range. In response, some embodiments may, in lieu of directly retrieving the set of data, retrieve the pre-calculated value for use as an aggregate feature value or to use to obtain an aggregate feature value.

Some embodiments may execute an additional database transaction based on the aggregated feature value, as indicated by block 324. Some embodiments may execute an additional database transaction based on the aggregated feature value. For example, after executing retrieval requests for different partitions, some embodiments may then calculate sums, median averages, mean averages, maximum values, minimum values, some other measurement of extrema based on the values retrieved from different partitions. Some embodiments may then use these values to perform further database transactions, such as permitting a database transaction to occur that changes one or more values stored in one or more records.

Some embodiments may determine a decision model result by providing the aggregated measurement as an input to a decision model. Based on this decision model result, the system sends a message to an endpoint to execute an additional network request to effectuate a database transaction in a distributed cache or effectuate another type of network operation. For example, a computer system may receive a transfer message from a user and perform operations described in this disclosure to retrieve values associated with the user. The computer system may then use the retrieved values to determine a maximum value, a median value, and a transaction rate. The computer system may then provide the maximum value, a median value, and a transaction rate to a machine learning model to determine a model result (e.g., an indication that a transaction matches a known utilization pattern or that the transaction does not match a known utilization pattern). Based on the model result, some embodiments may then send a transfer-executing query to a networked database endpoint or effectuate another type of network operation, such as checking the data a networked cache, modifying one or more records in a database connected to a network, etc.

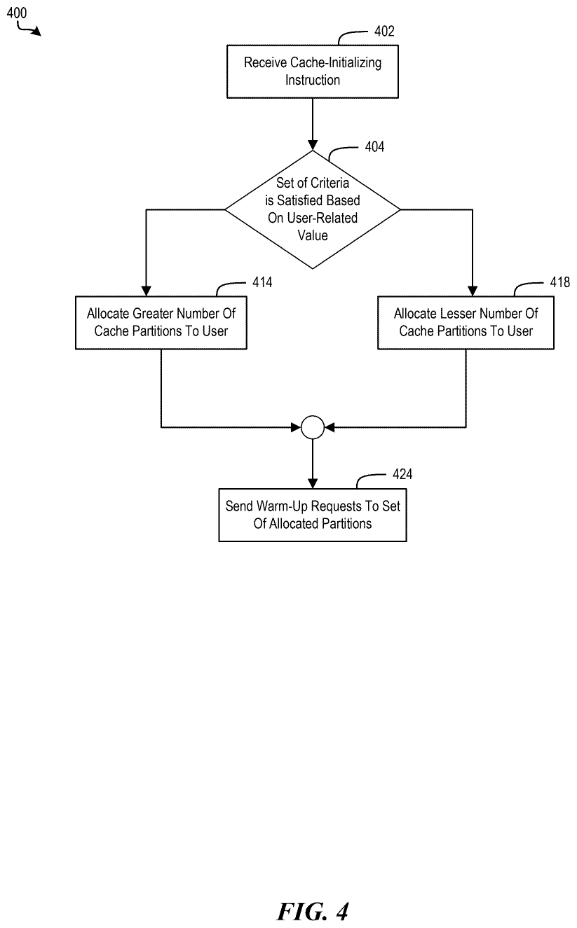

FIG. 4 shows a flowchart of a process 400 for initializing multiple partitions, in accordance with one or more embodiments. Some embodiments may be configured to automatically generate one or more cache partitions for a user based on receiving records for the user and a determination that no partitions have been made for that user yet. Some embodiments may receive a transaction for a new user and determine that the user has no allocated cache memory partitions. Some embodiments may then send a configuration payload for a cache node to a central configuration management service. For example, the payload may specify parameters such as a cache's total memory allocation, an eviction policy, etc. For instance, some embodiments may receive instructions that cause a computer system to send, to a Redis cluster, a message to allocate 16GB of memory, serialize data using protocol buffers, and establish communication channels with a specified set of peer nodes, etc.

Some embodiments may receive cache-initializing instructions, as indicated by block 402. Some embodiments may generate new partitions for new shards Some embodiments may configure properties for destination cache partitions by using a set of partition parameters that are obtained from a pre-determined file (e.g., a configuration file), provided by a user, obtained from an API, or obtained from another data source. For example, some embodiments may obtain specifications such as a partition count, allocation strategy, data distribution method, and shard mapping. Some embodiments may then extract an existing set of data from a set of source cache partitions already being used and then load the existing set of data into the destination cache partitions. For example, some embodiments may scan a cache using SCAN commands to iterate through keys of cache, with each iteration retrieving a subset of keys and their corresponding values. Some embodiments may then transform the extracted data to match a destination cache's partition schema and load the transformed, extracted data into the destination cache partitions.

Some embodiments may determine whether a set of criteria for allocating a greater number of cache partitions to a user is satisfied based on a user-related value, as indicated by block 404. Some embodiments may determine different numbers of cache partitions for different sets of cache partitions, such as assigning five cache partitions to a first user as a first set of cache partitions and assigning one cache partition to a second user as a second set of cache partitions. For example, some embodiments may allocate five virtual partitions distributed between five physical partitions to a first user. Some embodiments may then receive instructions to generate one or more partitions for a second user and determine whether to allocate a single, un-sharded cache partition for the second user or allocate multiple virtual shards to the second user based on a user-specific value stored in association with the second user.

Some embodiments may then receive a second set of database transaction records for the second user and allocate a second set of cache partitions to the second user based on a value associated with the second user (e.g., a database transaction rate threshold). In some embodiments, the first set of cache partitions and the second set of cache partitions have different counts of partitions.

Some embodiments may determine workload traffic indicating traffic for the multiple networked nodes. For example, some embodiments may analyze incoming data requests and measure the volume of traffic directed to each networked node. Some embodiments may determine that the workload traffic exceeds a workload threshold by analyzing the number of transaction queries per day per partition. For example, if the workload threshold is set to 1000 transaction queries per day per partition, some embodiments may detect that a particular partition has processed 1,200 transaction queries in a single day and thus that the workload threshold is exceeded. In response to determining that the workload traffic exceeds the workload threshold, some embodiments may increase the partition count of the cache partitions. For example, if a particular partition processes 1,200 transaction queries in a single day while the threshold is 1000 transaction queries per day, then some embodiments may dynamically allocate additional partitions to distribute the workload more evenly.

By performing such operations some embodiments may dynamically change (e.g., increase or decrease) the number of partitions of a workload exceeds a certain threshold (e.g., 1,200 transaction queries per day per partition).

In response to a determination that the set of criteria is satisfied, some embodiments may proceed to operations described for block 414. Otherwise, operations of the process 400 may proceed operations described for block 418. Furthermore, it should be understood that some embodiments may employ more sophisticated methods, such as using a linear that may determine how many partitions to generate and allocate to a user based on a linear formula, a multi-step binning function, etc.

Some embodiments may allocate a greater number of cache partitions to a user, as indicated by block 414. For example, some embodiments may allocate five cache partitions to a user based on a determination that a database transaction rate for the user exceeds a threshold, such averaging more than five effectuated database transactions per day. Some embodiments may determine what number of partitions to allocate to a user based on one or more user-related values associated with the user. For example, some embodiments may bin the number of transactions per hour for a user into integers of ten and assign numbers to the integers.

Some embodiments may allocate a lesser number of cache partitions to a user, as indicated by block 418. For example, some embodiments may allocate a single cache partition of a cache to a user based on a determination that a database transaction rate for the user is less than a threshold, such averaging less than five effectuated database transactions per day. In some embodiments, the allocation of a single partition to a user or a set number of multiple partitions to a user may be a binary choice. Alternatively, or additionally, some embodiments may allocate different numbers of partitions to a user based on one or more categories associated with a user or values of the user (e.g., a value stored in a record of the user).

Some embodiments may send a set of warm-up requests to the set of allocated partitions, as indicated by block 424. Some embodiments may execute a set of warm-up requests to retrieve values from the destination cache partitions after loading the existing set of data, before executing the first retrieval request. For example, after loading the existing set of data into the destination cache partitions, some embodiments may execute a set of warm-up requests that include instructions to query the destination cache partitions for a set of user-specific values (e.g., by using “GET user:144,” setting a time value, or updating multiple fields in the destination cache.

The above-described embodiments of the present disclosure are presented for purposes of illustration and not of limitation, and the present disclosure is limited only by the claims which follow. Furthermore, it should be noted that the features and limitations described in any embodiment may be applied to one or more other embodiments herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods. Furthermore, not all operations of a flowchart need to be performed. In addition, the systems and methods described herein may be performed in real time. It should also be noted that the systems and/or methods described above may be applied to, or used in accordance with, other systems and/or methods.

Furthermore, the computing devices described in this disclosure may be any type of computing device unless otherwise stated, including, but not limited to, a laptop computer, a tablet computer, a hand-held computer, and/or other computing equipment (e.g., a server), including “smart,” wireless, wearable, and/or mobile devices. For example, while the client device 102 of FIG. 1 may be a head-mounted device, another type of mobile computing device may be possible. Furthermore, the embodiments described in this disclosure may include an individual device that performs some or all the operations described in this disclosure. Alternatively, other embodiments may include multiple computing devices acting collectively to perform some or all the operations described in this disclosure.

As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety (i.e., the entire portion), of a given item (e.g., data) unless the context clearly dictates otherwise. Furthermore, a “set” may refer to a singular form or a plural form, such that a “set of items” may refer to one item or a plurality of items.

In some embodiments, the operations described in this disclosure may be implemented in a set of processing devices (e.g., a digital processor, an analog processor, a digital circuit designed to process information, an analog circuit designed to process information, a state machine, and/or other mechanisms for electronically processing information). The processing devices may include one or more devices executing some or all of the operations of the methods in response to instructions stored electronically on one or more non-transitory, machine-readable media (e.g., a set of machine-readable storage media), such as an electronic storage medium. Furthermore, the use of the term “media” may include a single medium or combination of multiple media, such as a first medium and a second medium. One or more non-transitory machine-readable media storing instructions may include instructions included on a single medium or instructions distributed across multiple media. For example, non-transitory media may act as one or more memory, where one or more memory may store program instructions that are written as source files or written in machine-executable program code. The processing devices may include one or more devices configured through hardware, firmware, and/or software to be specifically designed for the execution of one or more of the operations of the methods.

In some embodiments, the various computer systems and subsystems illustrated in FIG. 1 or FIG. 2 may include one or more computing devices that are programmed to perform the functions described herein. The computing devices may include one or more electronic storages (e.g., a set of databases accessible to one or more applications depicted in the system 100), one or more physical processors programmed with one or more computer program instructions, and/or other components. For example, the set of databases may include one or more relational databases. Alternatively, or additionally, the set of databases or other electronic storage used in this disclosure may include one or more non-relational databases.

The computing devices may include communication lines or ports to enable the exchange of information with a set of networks (e.g., a network used by the system 100) or other computing platforms via wired or wireless techniques. The network may include the internet, a mobile phone network, a mobile voice or data network (e.g., a 5G or Long-Term Evolution (LTE) network), a cable network, a public switched telephone network, or other types of communication networks or combination of communication networks. A network described by devices or systems described in this disclosure may include one or more communications paths, such as Ethernet, a satellite path, a fiber-optic path, a cable path, a path that supports internet communications (e.g., IPTV), free-space connections (e.g., for broadcast or other wireless signals), Wi-Fi, Bluetooth, near field communication, or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Each of these devices described in this disclosure may also include electronic storages. The electronic storage may include one or more non-transitory machine-readable media (e.g., storage media) that electronically stored information. The storage media of the electronic storages may include one or both of (i) system storage that is provided integrally (e.g., substantially non-removable) with servers or client computing devices, or (ii) removable storage that is removably connectable to the servers or client computing devices via port (e.g., a USB port, a firewire port, etc.) or drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage may include one or more virtual storage resources (e.g., cloud storage, a virtual private network, and/or other virtual storage resources). An electronic storage may store software algorithms, information determined by the processors, information obtained from servers, information obtained from client computing devices, or other information that enables the functionality as described herein.

The processors may be programmed to provide information processing capabilities in the computing devices. As such, the processors may include one or more of a digital processor, an analog processor, a digital circuit designed to process information, an analog circuit designed to process information, a state machine, and/or other mechanisms for electronically processing information. In some embodiments, the processors may include a plurality of processing units. These processing units may be physically located within the same device, or the processors may represent the processing functionality of a plurality of devices operating in coordination. The processors may be programmed to execute computer program instructions to perform functions described herein of subsystems described in this disclosure or other subsystems. The processors may be programmed to execute computer program instructions by software; hardware; firmware; some combination of software, hardware, or firmware; and/or other mechanisms for configuring processing capabilities on the processors.

It should be appreciated that the description of the functionality provided by the different subsystems described herein is for illustrative purposes, and is not intended to be limiting, as any of the subsystems described in this disclosure may provide more or less functionality than is described. For example, one or more of subsystems described in this disclosure may be eliminated, and some or all of its functionality may be provided by other ones of subsystems described in this disclosure. As another example, additional subsystems may be programmed to perform some, or all of the functionality attributed herein to one of the subsystems described in this disclosure.

With respect to the components of computing devices described in this disclosure, each of these devices may receive content and data via input/output (I/O) paths. Each of these devices may also include processors and/or control circuitry to send and receive commands, requests, and other suitable data using the I/O paths. The control circuitry may comprise any suitable processing, storage, and/or I/O circuitry. Further, some or all of the computing devices described in this disclosure may include a user input interface and/or user output interface (e.g., a display) for use in receiving and displaying data. In some embodiments, a display such as a touchscreen may also act as a user input interface. It should be noted that in some embodiments, one or more devices described in this disclosure may have neither user input interface nor displays and may instead receive and display content using another device (e.g., a dedicated display device such as a computer screen and/or a dedicated input device such as a remote control, mouse, voice input, etc.). Additionally, one or more of the devices described in this disclosure may run an application (or another suitable program) that performs one or more operations described in this disclosure.

Although the present invention has been described in detail for the purpose of illustration based on what is currently considered to be the most practical and preferred embodiments, it is to be understood that such detail is solely for that purpose and that the invention is not limited to the disclosed embodiments but, on the contrary, is intended to cover modifications and equivalent arrangements that are within the scope of the appended claims. For example, it is to be understood that the present invention contemplates that, to the extent possible, one or more features of any embodiment may be combined with one or more features of any other embodiment.

As used throughout this application, the word “may” is used in a permissive sense (i.e., meaning having the potential to), rather than a mandatory sense (i.e., meaning must). The words “include,” “including,” “includes,” and the like mean including, but not limited to. As used throughout this application, the singular forms “a,” “an,” and “the” include plural referents unless the context clearly indicates otherwise. Thus, for example, reference to “an element” or “the element” includes a combination of two or more elements, notwithstanding the use of other terms and phrases for one or more elements, such as “one or more.” The term “or” is non-exclusive (i.e., encompassing both “and” and “or”), unless the context clearly indicates otherwise. Terms describing conditional relationships (e.g., “in response to X, Y,” “upon X, Y,” “if X, Y,” “when X, Y,” and the like) encompass causal relationships in which the antecedent is a necessary causal condition, the antecedent is a sufficient causal condition, or the antecedent is a contributory causal condition of the consequent (e.g., “state X occurs upon condition Y obtaining” is generic to “X occurs solely upon Y” and “X occurs upon Y and Z”). Such conditional relationships are not limited to consequences that instantly follow the antecedent obtaining, as some consequences may be delayed, and in conditional statements, antecedents are connected to their consequents (e.g., the antecedent is relevant to the likelihood of the consequent occurring). Statements in which a plurality of attributes or functions are mapped to a plurality of objects (e.g., a set of processors performing steps/operations A, B, C, and D) encompass all such attributes or functions being mapped to all such objects and subsets of the attributes or functions being mapped to subsets of the attributes or functions (e.g., both/all processors each performing steps/operations A-D, and a case in which processor 1 performs step/operation A, processor 2 performs step/operation B and part of step/operation C, and processor 3 performs part of step/operation C and step/operation D), unless otherwise indicated. Further, unless otherwise indicated, statements that one value or action is “based on” another condition or value encompass both instances in which the condition or value is the sole factor and instances in which the condition or value is one factor among a plurality of factors.

Unless the context clearly indicates otherwise, statements that “each” instance of some collection has some property should not be read to exclude cases where some otherwise identical or similar members of a larger collection do not have the property (i.e., each does not necessarily mean each and every). Limitations as to the sequence of recited steps should not be read into the claims unless explicitly specified (e.g., with explicit language like “after performing X, performing Y”) in contrast to statements that might be improperly argued to imply sequence limitations (e.g., “performing X on items, performing Y on the X'ed items”) used for purposes of making claims more readable rather than specifying a sequence. Statements referring to “at least Z of A, B, and C,” and the like (e.g., “at least Z of A, B, or C”), refer to at least Z of the listed categories (A, B, and C) and do not require at least Z units in each category. Unless the context clearly indicates otherwise, it is appreciated that throughout this specification discussions utilizing terms such as “processing,” “computing,” “calculating,” “determining,” or the like refer to actions or processes of a specific apparatus, such as a special purpose computer or a similar special purpose electronic processing/computing device. Furthermore, unless indicated otherwise, updating an item may include generating the item or modifying an existing item. Thus, updating a record may include generating a record or modifying the value of an already-generated value in a record. Additionally, as used in the specification, “a portion” refers to a part of, or the entirety of (i.e., the entire portion), a given item (e.g., data) unless the context clearly dictates otherwise.

Unless the context clearly indicates otherwise, ordinal numbers used to denote an item do not define the item's position. For example, an item that may be a first item of a set of items even if the item is not the first item to have been added to the set of items or is otherwise indicated to be listed as the first item of an ordering of the set of items. Thus, for example, if a set of items is sorted in a sequence from “item 1,” “item 2,” and “item 3,” the first item of a set of items may be “item 2” unless otherwise stated.

### Enumerated Embodiments

The present techniques will be better understood with reference to the following enumerated clauses:
1. A method comprising: allocating cache partitions to a user, wherein the cache partitions is distributed between multiple networked nodes; storing a set of record subsets in the cache partitions; and determining an aggregated feature value by executing retrieval requests for the partitions.
2. A method comprising: allocating, based on a user-specific value stored in association with a user, cache partitions to the user, wherein the cache partitions is distributed between multiple networked nodes and comprises a first partition and a second partition; storing a first record subset in the first partition and a second record subset in the second partition; determining an aggregated feature value by executing, based on an aggregated data request, a first retrieval request for the first partition and a second retrieval request for the second partition.
3. A method comprising: allocating, based on a user-specific value stored in association with a user, cache partitions to the user, wherein the cache partitions is distributed between multiple networked nodes and comprises a first partition and a second partition; storing a first record subset in the first partition and a second record subset in the second partition; determining an aggregated feature value by executing, based on an aggregated data request, a first retrieval request for the first partition and a second retrieval request for the second partition; and executing an additional database transaction based on the aggregated feature value.
4. A method comprising: in connection with receiving requests for a user from a client device via the Internet, allocating Internet-connected cache partitions stored in multiple server-side Internet-connected nodes on the Internet by selecting a number of partitions for the Internet-connected cache partitions based on a request execution rate stored in association with the user, wherein the Internet-connected cache partitions are distributed between the multiple server-side Internet-connected nodes; storing a first request record subset in a first partition of the Internet-connected cache partitions and a second request record subset in a second partition of the Internet-connected cache partitions; determining search values based on a payload request related to the user; and determining an aggregated measurement by (i) concurrently executing, based on the search values, a first retrieval request for the first partition and a second retrieval request for the second partition and (ii) sending a first payload resulting from the first retrieval request and a second payload resulting from the second retrieval request to a computing node; determining a decision model result by providing, as an input, the aggregated measurement to a decision model; and sending a message to an endpoint to execute an additional network request based on the decision model result.
5. A method for fast measurement retrieval by intelligently allocating distributed caches, comprising: allocating, based on a user-specific value stored in association with a user, cache partitions to the user, wherein the cache partitions is distributed between multiple networked nodes and comprises a first partition and a second partition; storing a first record subset of records associated with the user in the first partition and a second record subset of the records in the second partition; determining a set of search values based on a request related to the user; executing, based on the set of search values, a first retrieval request for the first partition and a second retrieval request for the second partition to obtain a first payload from the first partition and a second payload from the second partition; determining an aggregated feature value based on the first payload and the second payload; and executing an additional database transaction based on the aggregated feature value.
6. The method of any of the above embodiments, wherein a node count of the multiple networked nodes is equal to or greater than a partition count of the cache partitions.
7. The method of any of the above embodiments, wherein: a record of the first record subset comprises a timestamp; and storing the first record subset comprises: determining a modulo based on the timestamp and a count of the cache partitions; and selecting the first partition for storing the record based on the modulo.
8. The method of any of the above embodiments, wherein a database transaction of the first record subset comprises a serialized protobuffer.
9. The method of any of the above embodiments, wherein the cache partitions are a first set of cache partitions, further comprising: receiving second records associated with a second user; allocating a second set of cache partitions to the second user based on a second user-specific value stored in association with the second user, wherein the first set of cache partitions and the second set of cache partitions have different counts of partitions; and distributing the second records into the second set of cache partitions.
10. The method of any of the above embodiments, wherein the cache partitions are a first set of cache partitions, further comprising: receiving second records associated with a second user; allocating a single cache partition to the second user based on a second user-specific value stored in association with the second user; and storing the second records in the single cache partition.
11. The method of any of the above embodiments, further comprising: determining a workload traffic indicating traffic for the multiple networked nodes; determining that the workload traffic exceeds a workload threshold; and in response to determining that the workload traffic exceeds the workload threshold, increasing a partition count of the cache partitions.
12. The method of any of the above embodiments, wherein the cache partitions are stored on a first set of nodes, further comprising: allocating an additional partition on a computation node associated with a time range for the user; storing, in the additional partition in association with the user, at least one record of the records associated with the user; and determining a result indicating that the set of search values exceeds a range associated with the additional partition, wherein executing the first retrieval request and the second retrieval request comprises executing the first retrieval request and the second retrieval request in response to the result.
13. The method of any of the above embodiments, further comprising: receiving a second request comprising a second search value; determining a second result indicating that the second search value does not exceed the range associated with the additional partition; and executing a third retrieval request for values in the additional partition without executing retrieval requests for the first partition or the second partition based on the second result.
14. The method of any of the above embodiments, further comprising: receiving a second request comprising a second search value; determining a pre-calculated value comprising at least one of a maximum value, minimum value, median value, or mean average value based on values stored in the computation node; determining an additional result indicating that the second search value does not exceed the range associated with the additional partition; and executing a third retrieval request for the pre-calculated value without executing retrieval requests for the first partition or the second partition based on the additional result.
15. The of any of the above embodiments, wherein each respective partition of the cache partitions is stored in a respective node of the multiple networked nodes.
16. The of any of the above embodiments, the operations further comprising: obtaining a second feature calculation request; detecting that the first partition is inaccessible after obtaining the second feature calculation request; determining a partial result based on values stored in the second partition without using values stored in the first partition in response to detecting that the first partition is inaccessible; and executing a second additional database transaction based on the partial result.
17. The of any of the above embodiments, wherein the cache partitions are destination cache partitions, and wherein allocating the destination cache partitions to the user comprises: configuring properties for the destination cache partitions based on a set of partition parameters; extracting an existing set of data from a set of source cache partitions; loading the existing set of data into the destination cache partitions; and executing, before executing the first retrieval request, a set of warm-up requests to retrieve values from the destination cache partitions after the loading of the existing set of data.
18. The of any of the above embodiments, wherein first records comprise the first record subset and the second record subset, wherein the cache partitions are a first set of cache partitions, the operations further comprising: receiving second records associated with a second user; allocating a second set of cache partitions to the second user based on a second user-specific value stored in association with the second user, wherein the first set of cache partitions and the second set of cache partitions have different counts of partitions; and distributing the second records into the second set of cache partitions.
19. The of any of the above embodiments, wherein: a record of the first record subset comprises a timestamp; and storing the first record subset comprises: determining a modulo based on the timestamp and a count of the cache partitions; and selecting the first partition for storing the record based on the modulo.
20. The of any of the above embodiments, wherein first records comprise the first record subset and the second record subset, wherein the cache partitions are a first set of cache partitions, the operations further comprising: receiving second records associated with a second user; allocating a single cache partition to the second user based on a second user-specific value stored in association with the second user; and storing the second records in the single cache partition.
21. The of any of the above embodiments, the operations further comprising: determining a workload traffic indicating traffic for the multiple networked nodes; determining that the workload traffic exceeds a workload threshold; and in response to determining the workload traffic exceeds the workload threshold, increasing partition count of the cache partitions.
22. The of any of the above embodiments, wherein records comprise the first record subset and the second record subset, and wherein the cache partitions are stored on a first set of nodes, the operations further comprising: allocating an additional partition on a computation node associated with a time range for the user; storing at least one record of the records in association with the user; and determining a result indicating that a set of search values of the aggregated data request exceeds a range associated with the additional partition, wherein executing the first retrieval request and the second retrieval request comprises executing the first retrieval request and the second retrieval request in response to the result.
23. A tangible, non-transitory, machine-readable medium storing instructions that, when executed by a data processing apparatus, cause the data processing apparatus to perform operations comprising those of any of embodiments 1-22.
24. A system comprising one or more processors; and memory storing instructions that, when executed by the processors, cause the processors to effectuate operations comprising those of any of embodiments 1-22.
25. A system comprising means for performing any of embodiments 1-22.

What is claimed is:

1. A system for fast measurement retrieval by intelligently allocating Internet distributed caches for low latency communication over the Internet, the system comprising:
one or more processors; and
one or more memory storing program instructions that, when executed by the one or more processors, causes operations comprising:
in connection with receiving requests for a user from a client device via the Internet, allocating Internet-connected cache partitions stored in multiple server-side Internet-connected nodes on the Internet by selecting a number of partitions for the Internet-connected cache partitions based on a request execution rate stored in association with the user, wherein the Internet-connected cache partitions are distributed between the multiple server-side Internet-connected nodes;
storing a first request record subset in a first partition of the Internet-connected cache partitions and a second request record subset in a second partition of the Internet-connected cache partitions;
determining search values based on a payload request related to the user; and
determining an aggregated measurement by (i) concurrently executing, based on the search values, a first retrieval request for the first partition and a second retrieval request for the second partition and (ii) sending a first payload resulting from the first retrieval request and a second payload resulting from the second retrieval request to a computing node;
determining a decision model result by providing, as an input, the aggregated measurement to a decision model; and
sending a message to an endpoint to execute an additional network request based on the decision model result.

2. A method for fast measurement retrieval by intelligently allocating distributed caches, comprising:
allocating, based on a user-specific value stored in association with a user, cache partitions to the user, wherein the cache partitions is distributed between multiple networked nodes and comprises a first partition and a second partition;
storing a first record subset of records associated with the user in the first partition and a second record subset of the records associated with the user in the second partition;
determining a set of search values based on a request related to the user;
executing, based on the set of search values, a first retrieval request for the first partition and a second retrieval request for the second partition to obtain a first payload from the first partition and a second payload from the second partition;
determining an aggregated feature value based on the first payload and the second payload; and
executing an additional database transaction based on the aggregated feature value.

3. The method of claim 2, wherein a node count of the multiple networked nodes is equal to or greater than a partition count of the cache partitions.

4. The method of claim 2, wherein:
a record of the first record subset comprises a timestamp; and
storing the first record subset comprises:
determining a modulo based on the timestamp and a count of the cache partitions; and
selecting the first partition for storing the record based on the modulo.

5. The method of claim 2, wherein a database transaction of the first record subset comprises a serialized protobuffer.

6. The method of claim 2, wherein the cache partitions are a first set of cache partitions, further comprising:
receiving second records associated with a second user;
allocating a second set of cache partitions to the second user based on a second user-specific value stored in association with the second user, wherein the first set of cache partitions and the second set of cache partitions have different counts of partitions; and
distributing the second records into the second set of cache partitions.

7. The method of claim 2, wherein the cache partitions are a first set of cache partitions, further comprising:
receiving second records associated with a second user;
allocating a single cache partition to the second user based on a second user-specific value stored in association with the second user; and
storing the second records in the single cache partition.

8. The method of claim 2, further comprising:
determining a workload traffic indicating traffic for the multiple networked nodes;
determining that the workload traffic exceeds a workload threshold; and
in response to determining that the workload traffic exceeds the workload threshold, increasing a partition count of the cache partitions.

9. The method of claim 2, wherein the cache partitions are stored on a first set of nodes, further comprising:
allocating an additional partition on a computation node associated with a time range for the user;
storing, in association with the user in the additional partition, at least one record of the records associated with the user; and
determining a result indicating that the set of search values exceeds a range associated with the additional partition, wherein executing the first retrieval request and the second retrieval request comprises executing the first retrieval request and the second retrieval request in response to the result.

10. The method of claim 9, further comprising:
receiving a second request comprising a second search value;
determining a second result indicating that the second search value does not exceed the range associated with the additional partition; and
executing a third retrieval request for values in the additional partition without executing retrieval requests for the first partition or the second partition based on the second result.

11. The method of claim 9, further comprising:
receiving a second request comprising a second search value;
determining a pre-calculated value comprising at least one of a maximum value, minimum value, median value, or mean average value based on values stored in the computation node;
determining an additional result indicating that the second search value does not exceed the range associated with the additional partition; and
executing a third retrieval request for the pre-calculated value without executing retrieval requests for the first partition or the second partition based on the additional result.

12. One or more non-transitory machine-readable media storing program instructions that, when executed by one or more processors, cause operations comprising:
allocating, based on a user-specific value stored in association with a user, cache partitions to the user, wherein the cache partitions is distributed between multiple networked nodes and comprises a first partition and a second partition;
storing a first record subset in the first partition and a second record subset in the second partition;
determining an aggregated feature value by executing, based on an aggregated data request, a first retrieval request for the first partition and a second retrieval request for the second partition; and
executing an additional database transaction based on the aggregated feature value.

13. The one or more machine-readable media of claim 12, wherein each respective partition of the cache partitions is stored in a respective node of the multiple networked nodes.

14. The one or more machine-readable media of claim 12, the operations further comprising:
obtaining a second feature calculation request;
detecting that the first partition is inaccessible after obtaining the second feature calculation request;
determining a partial result based on values stored in the second partition without using values stored in the first partition in response to detecting that the first partition is inaccessible; and
executing a second additional database transaction based on the partial result.

15. The one or more machine-readable media of claim 12, wherein the cache partitions are destination cache partitions, and wherein allocating the destination cache partitions to the user comprises:
configuring properties for the destination cache partitions based on a set of partition parameters;
extracting an existing set of data from a set of source cache partitions;
loading the existing set of data into the destination cache partitions; and
executing, before executing the first retrieval request, a set of warm-up requests to retrieve values from the destination cache partitions after the loading of the existing set of data.

16. The one or more machine-readable media of claim 12, wherein first records comprise the first record subset and the second record subset, wherein the cache partitions are a first set of cache partitions, the operations further comprising:
receiving second records associated with a second user;
allocating a second set of cache partitions to the second user based on a second user-specific value stored in association with the second user, wherein the first set of cache partitions and the second set of cache partitions have different counts of partitions; and
distributing the second records into the second set of cache partitions.

17. The one or more machine-readable media of claim 12, wherein:
a record of the first record subset comprises a timestamp; and
storing the first record subset comprises:
determining a modulo based on the timestamp and a count of the cache partitions; and
selecting the first partition for storing the record based on the modulo.

18. The one or more machine-readable media of claim 12, wherein first records comprise the first record subset and the second record subset, wherein the cache partitions are a first set of cache partitions, the operations further comprising:
receiving second records associated with a second user;
allocating a single cache partition to the second user based on a second user-specific value stored in association with the second user; and
storing the second records in the single cache partition.

19. The one or more machine-readable media of claim 12, the operations further comprising:
determining a workload traffic indicating traffic for the multiple networked nodes;
determining that the workload traffic exceeds a workload threshold; and
in response to determining the workload traffic exceeds the workload threshold, increasing partition count of the cache partitions.

20. The one or more machine-readable media of claim 12, wherein records comprise the first record subset and the second record subset, and wherein the cache partitions are stored on a first set of nodes, the operations further comprising:
allocating an additional partition on a computation node associated with a time range for the user;
storing, in association with the user in the additional partition, at least one record of the records associated with the user; and
determining a result indicating that a set of search values of the aggregated data request exceeds a range associated with the additional partition, wherein executing the first retrieval request and the second retrieval request comprises executing the first retrieval request and the second retrieval request in response to the result.
